(19) United States
(12) Patent Application Publication
(10) Pub. No.: US 2002/0162626 A1
(43) Pub. Date: Nov. 7, 2002

(54) Tape automated bonding for packing connection band of flat display

(76) Inventors: Kun-Feng Huang, Tainan (TW); Hsin-Fa Hsu, Tainan (TW)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 09/875,731

(22) Filed: Jun. 6, 2001

(30) Foreign Application Priority Data
Nov. 4, 2000 (TW) 89123277

(51) Int. Cl. C09K 19/00

(52) U.S. Cl. 156/303.1; 428/1.6; 156/228

(57) ABSTRACT

This invention is related to the configuration of a tape automated bonding for packaging a connection device of a LCD display, in which the shape of the bending slits is designed to have larger widths close to the two opposing ends and have a smaller width at the central area. This invention can avoid damage to the conduction layer by vibration at the bending slits. In addition, it is not necessary to increase or change the size of the LCD display module.

### CROSS-REFERENCES TO RELATED APPLICATIONS

Not Applicable

### STATEMENT REGARDING FEDERALLY SPONSORED RESEARCH OR DEVELOPMENT

Not Applicable BACKGROUND OF THE INVENTION

1. Field of the Invention

This invention is related to the construction of a tape automated bonding for a flat display, in particular, the configuration design of the bending slits for the tape automated bonding for packaging a connection device of a LCD display, so as to reduce the possibility of breakage of the connection device in a vibrational environment.

2. Description of the Related Art

With the rapid development of the computer industry, the techniques for producing various kinds of flat displays improve day by day. As a result, the production costs and the selling prices for liquid crystal display (LCD) or other types of relatively thin displays continue to decline and thus, the application thereof becomes more popular. The requirements of the dimension and the weight of the LCD for notebook computers are particularly strict. The computer industry keeps on working at and developing better designs to improve the overall configuration of the LCD so that the dimension of the housing for the LCD is as small as possible and that the size of the overall LCD display approaches the size of the LCD panel which actually provides the displaying function. That is, the primary object is to minimize the dimension and location of the elements rather than the LCD panels themselves.

To reduce the overall dimension of the LCD display, one conventional measure is to provide a plurality of connection regions between the LCD panel 10 and the circuit board 12, such as eight connection regions 14 shown in FIGS. 1 and 2. Each of the connection regions 14 has a driving IC (integrated circuit) 16, as shown in the enlarged view of FIG. 3, which is mounted on a connection layer 18. The connection layer 18 includes a plurality of copper wires (not illustrated in the Figures) for transmitting Signals. The driving IC 16 and the connection layer 18 are further packaged and protected by, for example, a tape automated bonding (TAB) 20. The material used for the TAB 20 can be polyimide. Generally, two transverse bending slits 22 and 24 are formed on the TAB 20 which is bent along these two bending slits 22 and 24 so that the driving IC 16 and the circuit board 12 are placed at the back side of the LCD panel 10, as seen in FIG. 2. The overall space occupied by the LCD display module is thus reduced significantly. However, during test or actual application of the LCD display, it was found that the above design often results in breakage of the connection layer 18 at the two ends of the narrower bending slit 22 in a vibrational environment. Particularly, the connection layer 18 at the first and/or second connection regions 14 from the two opposite distal ends is most seriously damaged. FIG. 3 schematically shows the breakage 26 of the connection layer 18 after vibration. It is generally believed that the breakage of the connection layer 18 is caused by the stress directly introduced by vibration. Nevertheless, if a vibration test is performed on a LCD display module 28 shown in FIG. 6, as schematically illustrated in FIGS. 4 and 5, the maximum stress introduced from the vibration should take place at both distal ends and the central area of the module 28 according to stress analysis. But the real situation is that the connection layer 18 at the central connection region 14 is intact. Therefore, the reason for causing the breakage of the connection layer 18 is not simply introduced from the excessive vibration.

It is found that when the LCD display module 28 vibrates up and down, as shown in FIG. 7, the circuit board 12 and the LCD panel 10 still tend to keep their original lengths upon bending displacement because they are not integrally formed. In addition, the ends of the TAB 20 are constrained by the display frame 30, the up and down vibration thus produces shear displacement. That is, the shear stress at the central connection region 14 is minimal, and the shear stress increases for the connection regions 14 toward the two distal ends. FIG. 8 shows possible deformation conditions of the TAB 20 upon shear stress, wherein example (a) shows the deformation condition for the TAB 20 close to the central area, while example (b) shows the deformation condition for the TAB 20 close to the left end upon upward vibration or the TAB 20 close to the right end upon downward vibration.

The purpose of providing bending slits 22 and 24 on the TAB 20 is to facilitate the bending of the tape 20 at the bending slits 22 and 24. Thus, the connection layer 18 is not well protected and is relatively soft at the regions of the bending slits 22 and 24. The TAB 20 is usually made of polyimide or other relatively stiff material with the stiffness thereof greater than that of the soft and bendable conduction layer 18. Furthermore, the width of the TAB 20 between the two slits 22 and 24 is significantly larger than the widths of the two slits 22 and 24. Accordingly, as seen in FIG. 9, the TAB 20 between the two slits 22 and 24 hardly deforms upon the shear deformation. As a result, with reference to FIG. 10 , the conduction layer 18 is compressed at region (c) and pulled at region (d). The stress distribution on the bending slits 22 and 24 is thus uneven and the compressing and pulling situations on the slits 22 and 24 occur repeatedly during the vibration of the LCD display module 28.

The narrower bending slit 22 is bent into an arcuate shape with a radius of curvature R under vibration, as shown in FIG. 10. Generally, the stress on the slit 22 is approximately in reverse proportion to the radius of curvature R. That is, if the radius of curvature R decreases, the stress exerted on the slit 22 increases. If the conduction layer 18 bends into a sharp angle, as illustrated in FIG. 10, the radius of curvature R approaches zero, so that the stress exerted on the slit approaches infinite. Thus, the conduction layer 18 at the two ends of the narrower bending slit 22 cracks and forms breakage 26 as shown in FIG. 3. On the other hand, the connection regions 14 at the central area experience smaller shear and deformation as seen in FIG. 8. Thus, almost no breakage happens to the conduction layer 18 at the central area.

One of the possible measures for eliminating the above breakage is to increase the widths of the bending slits 22 and 24. It is also possible to provide no TAB 20 for the whole area between the two slits 22 and 24, as shown in FIG. 11. Accordingly, the stress concentration over the conduction layer 18 can be diminished. Moreover, such design can provide larger space for the conduction layer 18 to deform into a larger radius of curvature upon compression and pulling. However, if the width of the bending slit is too large and the width of the TAB 20 is too small, the conduction layer 18 will not deform along the configuration of related components but will bulge outwardly. Thus, the dimension of the LCD display module needs to be increased, otherwise, the conduction layer 18 may directly contact the display frame 30 and the conduction layer 18 could be easily damaged thereby.

### BRIEF SUMMARY OF THE INVENTION

It is therefore a primary object of this invention to provide a modified design over the shape and/or dimensional configuration of the bending slits for the TAB so as to prevent the conduction layer from breakage by vibration.

According to the major technical contents of this invention, the shape of the bending slits is designed to have larger widths close to the two opposing ends and have a smaller width at the central area. The advantage of this invention is that the conduction layer at the bending slits is not damaged by vibration. In addition, sufficient width for the TAB is reserved so that the conduction layer can still properly deform along the original components upon bending, and it is not necessary to increase the size of the display module.

The structures and characteristics of this invention can be realized by referring to the appended drawings and explanations of the preferred embodiments.

### BRIEF DESCRIPTION OF THE DRAWINGS

FIG. 1 is a schematic view showing the layout of a conventional LCD panel and a circuit board connected by a plurality of connection regions;

FIG. 2 is a schematic view showing that the circuit board of FIG. 1 is bent to the back side of the LCD panel through the connection regions;

FIG. 3 is a schematic planar view showing one connection region;

FIG. 4 and FIG. 5 schematically illustrate the LCD display module prior to and after deformation respectively on a clamp for vibration test;

FIG. 6 is a schematic end view of the LCD display module shown in FIG. 2;

FIG. 7 schematically shows the vibration deformation conditions for the LCD display module shown in FIG. 6;

FIG. 8 schematically shows the deformation of the connection regions at the central area and the two ends of the LCD display module;

FIG. 9 is a schematic end view showing the vibration deformation of the conduction layer and the TAB of the LCD display module;

FIG. 10 is a schematic side view illustrating the deformation of the bending slits upon stress;

FIG. 11 is a schematic side view illustrating the design of the widened bending slits;

FIG. 12 shows preferred embodiments of this invention wherein the bending slits have various shapes; and

FIG. 13 schematically shows the vibration deformation amount of the end connection region of the LCD display module.

### DETAILED DESCRIPTION OF THE INVENTION

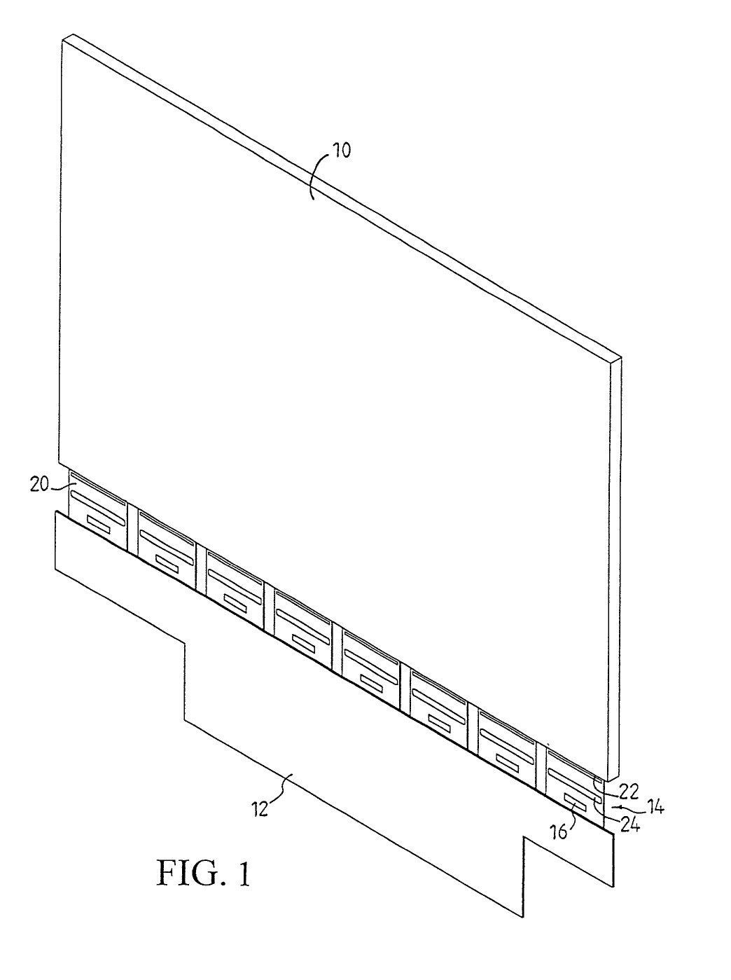

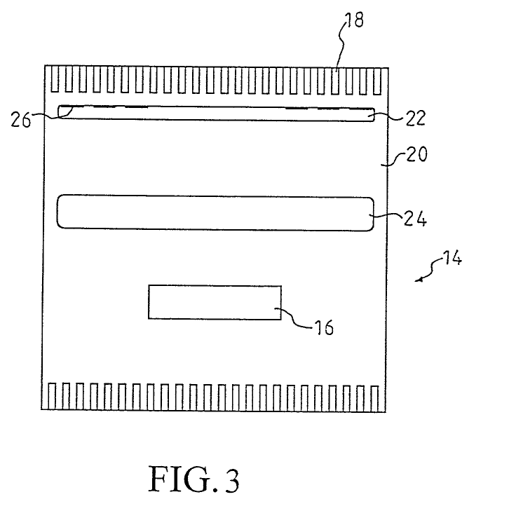

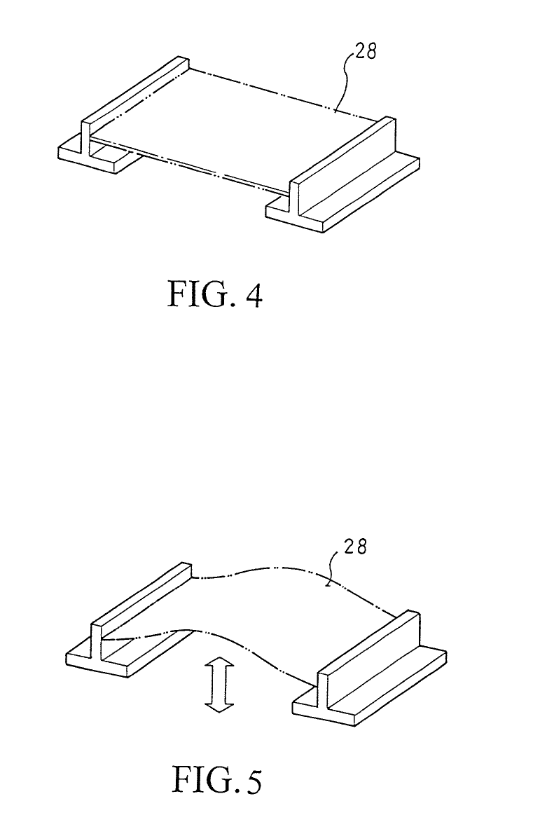

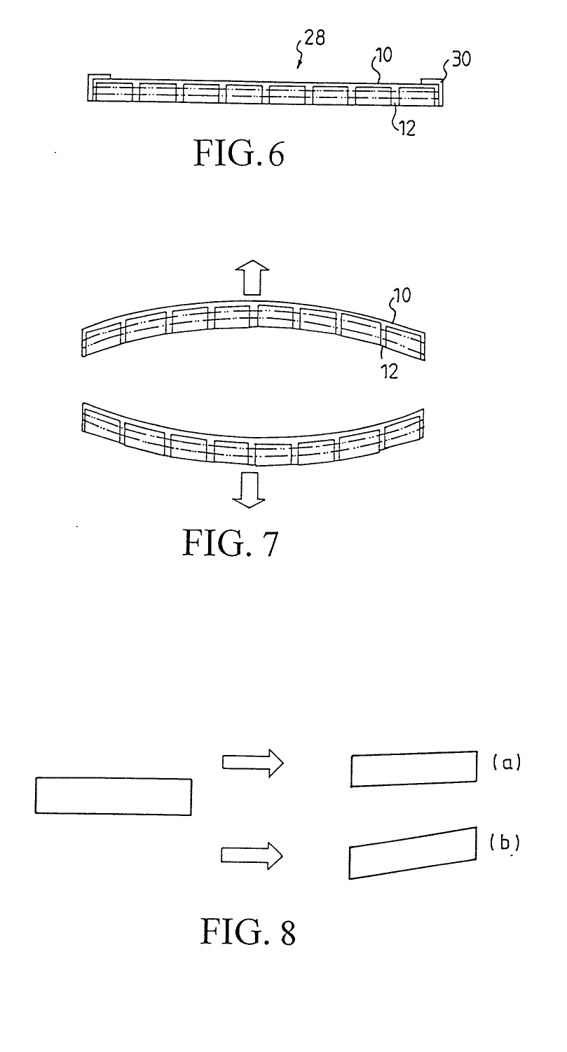

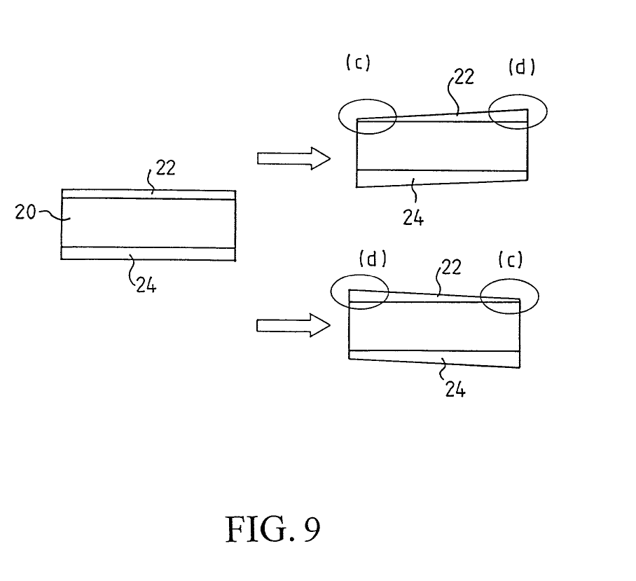

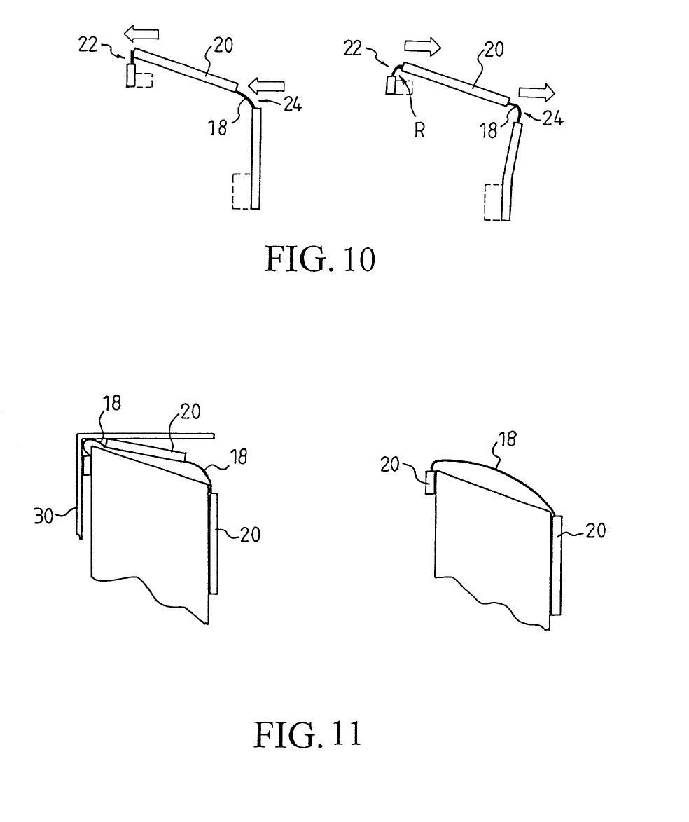

The basic configuration of the LCD panel 10, circuit board 12, and the arrangement of a plurality of TAB 20 in juxtaposition of this invention are substantially identical with those of the conventional art, as illustrated in FIGS. 1 to 3. Specifically, each of the TAB 20 is mounted on a conduction device which comprises a conduction layer 18 and a driving integrated circuit (IC) 16 mounted thereon. The conduction layer 18 has two ends, one of them is connected with the LCD panel 10, and the other is connected with the circuit board 12. A plurality of connection regions 14 are thus formed. Each of the connection regions 14 is covered and protected by a corresponding TAB thereon. The TAB 20 utilized in this invention is in the form of a roll of longitudinally continuous film, which is cut into pieces of a single unit as shown in FIG. 3 for the application on the connection regions 14. In one of the preferred embodiments of this invention, each of the TAB 20 has two substantially parallel and transverse extended bending slits 22 and 24 wherein the length of the bending slits 22 and 24 extends almost the entire width of the TAB 20. In the preferred embodiment of this invention, one bending slit 24 has a larger longitudinal width than that of the other bending slit 22, as illustrated in FIG. 3, so as to comply with the related configuration design of the LCD display module. Because the bending slit 24 with larger longitudinal width can provide larger space for deformation upon the compression and pulling, the breakage of the conduction layer 18 at the bending slit 24 resulting from stress concentration happens unlikely. Therefore, the preferred embodiment of this invention is specifically designed to prevent breakage at the narrower bending slit 22.

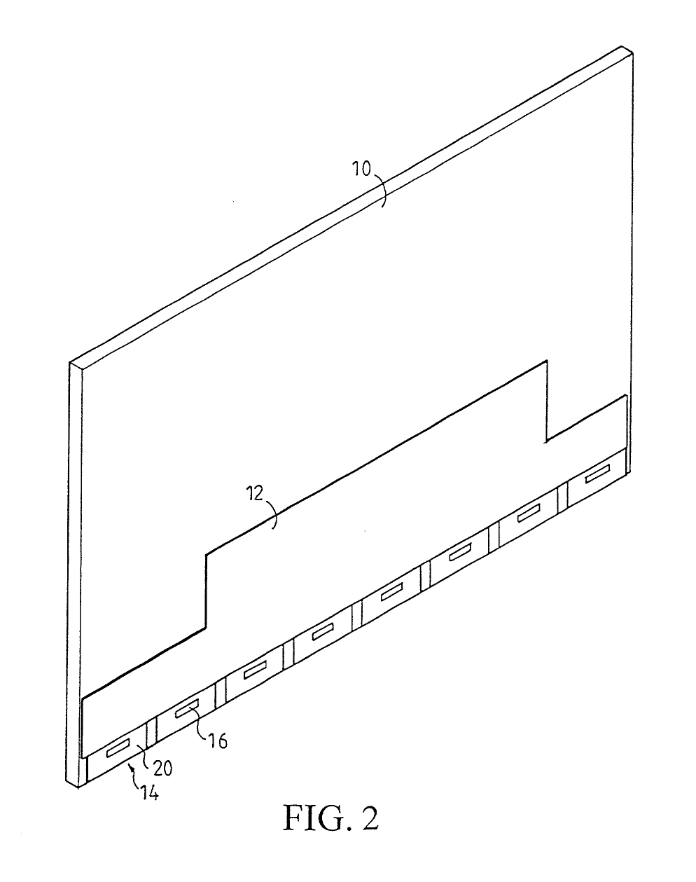

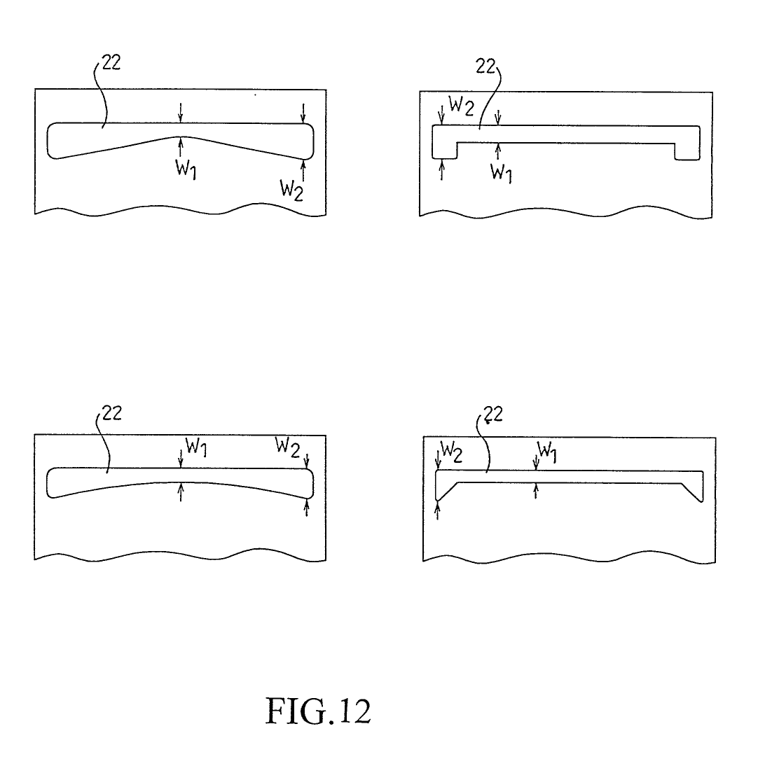

In the embodiment of this invention, the driving IC 16 and the circuit board 12 are bent to the back side of the LCD panel 10 along the two bending slits 22 and 24 on the conduction layer 18, as seen in FIG. 2, so that the circuit board 12 is substantially parallel with the LCD panel 10. One of the primary technical features of this invention is to modify the shape of the bending slit 22 on the TAB. As shown in FIG. 12, the bending slit 22 with narrower longitudinal width has a longitudinal width at the central region, and a longitudinal width W₂ at the two opposing end regions of the slit 22, and W₂ is larger than W₁. The specific shape of the bending slit 22 can have many different variations, as seen in FIG. 12. For example, the side of the bending slit 22 close to the LCD panel 10 has a straight edge, while the other edge linearly sloping and thus the width of this bending slit 22 linearly increases from the central region toward the two end regions at the side close to the circuit board 12. An alternative is to have the other edge arcuately sloping and thus the width of this bending slit 22 arcuately increases from the central region toward the two end regions at the side close to the circuit board 12. A further alternative is that the two end regions of this bending slit 22 are substantially in a triangular or rectangular shape with a larger longitudinal width. Generally, as long as the longitudinal width of the bending slit is smaller at the central region and is larger at the opposing end regions, the object of this invention can be achieved.

Because the longitudinal width of the bending slit 22 of this invention is enlarged at the two opposing ends, the bending slit 22 has a large space for deformation when the TAB 20 is compressed and pulled under the condition that the LCD display module is vibrated. Therefore, the stress concentration on the conduction layer 18 is considerably eliminated. Thus, this invention can effectively prevent damage on the conduction layer 18 at the bending slit 22 due to vibration. On the other hand, the central region of the bending slit 22 of this invention still keeps sufficient width of the TAB 20 so that the conduction layer 18 can remain in conformity with the original shape constrained by the configuration of the components and no oversized bulge will be formed after the bending of the conduction layer 18. Accordingly, there is no need to change or increase the design or the size of the LCD display module.

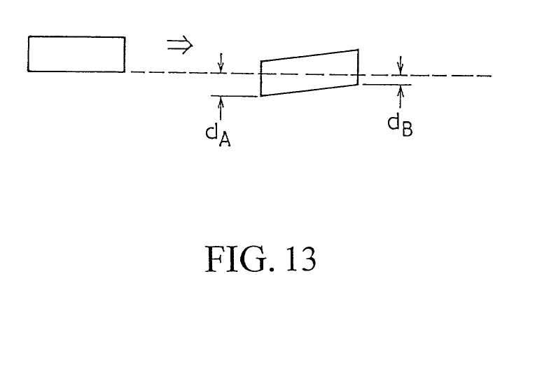

Generally, in designing the width W₂ of the two opposing end regions of the bending slit 22, the vibration amount of the LCD display module 28, that is, the deformation quantity of the bending slit 22 is taken into consideration. Assuming that the LCD display module 28 vibrates according to a sinusoidal wave, and the tested or analyzed maximum difference of the displacement for the TAB 20 due to vibration is d (d=|d_{A}−d_{B}|), as shown in FIG. 13, then the width W₂ of the two opposing end regions of the bending slit 22 will be no less than d, so as to meet the minimum requirement for compensating the vibration amount of the LCD display module 28.

This invention is a novel creation that makes a breakthrough to the conventional art. Aforementioned explanations, however, are directed to the description of preferred embodiments according to this invention. Various changes and implementations can be made by those skilled in the art without departing from the technical concept of this invention. Since this invention is not limited to the specific details described in connection with the preferred embodiments, changes to certain features of the preferred embodiments without altering the overall basic function of the invention are contemplated within the scope of the appended claims.

Sequence Listing

| | |
|---|---|
| 10 | LCD panel |
| 12 | circuit board |
| 14 | connection region |
| 16 | driving integrated circuit (IC) |
| 18 | conduction layer |
| 20 | tape automated bonding (TAB) |
| 22 | bending slit |
| 24 | bending slit |
| 26 | breakage |
| 28 | LCD display module |
| 30 | display frame |

1. A tape automated bonding for packaging a connection device of a flat display, in which the connection device has two opposing ends for longitudinally electric connection with a display panel and a circuit board respectively; the tape automated bonding comprises:
a transverse width;
at least one bending slit extending along the transverse width;
the at least one bending slit has two opposing end regions and a central region between the two end regions, wherein the two end regions have a longitudinal width and the central region has a longitudinal width smaller than the longitudinal width of the two end regions.

2. The tape automated bonding according to claim 1, wherein the tape automated bonding forms two elongated bending slits thereon.

3. The tape automated bonding according to claim 2, wherein one of the two bending slits has a straight edge at a side close to the display panel, and has an edge linearly sloping from the central region toward the two end regions at a side close to the circuit board.

4. The tape automated bonding according to claim 2, wherein one of the two bending slits has a straight edge at a side close to the display panel, and has an edge arcuately sloping from the central region toward the two end regions at a side close to the circuit board.

5. The tape automated bonding according to claim 2, wherein one of the two bending slits has a straight edge at a side close to the display panel, and has the two end regions each being substantially in a triangular shape.

6. The tape automated bonding according to claim 2, wherein one of the two bending slits has a straight edge at a side close to the display panel, and has the two end regions each being substantially in a rectangular shape.

7. A roll of tape automated bonding for packaging a connection device of a flat display, in which the connection device has two opposing ends for longitudinally electric connection with a display panel and a circuit board respectively, the roll of tape automated bonding includes a plurality of tape automated bonding units serially connected with one another, wherein each of the tape automated bonding unit comprises:
a transverse width;
at least one bending slit extending along the transverse width;
the at least one bending slit has two opposing end regions and a central region between the two end regions, wherein the two end regions have a longitudinal width and the central region has a longitudinal width smaller than the longitudinal width of the two end regions.

8. The roll of tape automated bonding according to claim 7, wherein each of the tape automated bonding unit forms two elongated bending slits thereon.

9. The roll of tape automated bonding according to claim 8, wherein one of the two bending slits has a straight edge at a side close to the display panel, and has an edge linearly sloping from the central region toward the two end regions at a side close to the circuit board.

10. The roll of tape automated bonding according to claim 8, wherein one of the two bending slits has a straight edge at a side close to the display panel, and has an edge arcuately sloping from the central region toward the two end regions at a side close to the circuit board.

11. The roll of tape automated bonding according to claim 8, wherein one of the two bending slits has a straight edge at a side close to the display panel, and has the two end regions each being substantially in a triangular shape.

12. The roll of tape automated bonding according to claim 8, wherein one of the two bending slits has a straight edge at a side close to the display panel, and has the two end regions each being substantially in a rectangular shape.
